(19) United States
(12) Patent Application Publication
(10) Pub. No.: US 2026/0342217 A1
(43) Pub. Date: Oct. 29, 2026

(54) ENHANCED SOFT STARTS FOR STACKED HALF BRIDGE VOLTAGE CONVERTERS

(71) Applicant: TEXAS INSTRUMENTS INCORPORATED, Dallas, TX (US)

(72) Inventors: Brent McDonald, Murphy, TX (US); Pradeep Shenoy, Richardson, TX (US)

(21) Appl. No.: 19/193,633

(22) Filed: Apr. 29, 2025

(51) Int. Cl. H02M 1/36; H02M 3/335

(52) U.S. Cl. CPC H02M 1/36; H02M 3/33592

(57) ABSTRACT

The present disclosure relates to a voltage converter that includes a first transistor, a second transistor, a third transistor, and a fourth transistor coupled in series between a voltage input and a ground. In one example embodiment, a technique for soft starting the voltage converter is provided. The technique first includes operating the second and third transistors at a first duty cycle and operating the first and fourth transistors at a second duty cycle. Next, the technique includes causing an increase of the second duty cycle until the second duty cycle matches the first duty cycle, while maintaining the second duty cycle in-phase with respect to the first duty cycle. Finally, the technique includes operating the first, second, third, and fourth transistors to transition the voltage converter from a first energy transfer state to a second energy transfer state.

### TECHNICAL FIELD

Aspects of the disclosure are related to voltage converters and control, and in particular, to controlling the switches of multilevel half bridge arrangements to improve soft starts.

### BACKGROUND

A voltage converter is a device that regulates the voltage levels of a power source by either increasing (stepping up) or decreasing (stepping down) the output voltage based on the voltage requirements of the associated system. For example, in electric vehicles (EVs), a voltage converter is used to ensure that the appropriate amount of voltage is being supplied from the EV battery pack to the various low-voltage components of the EV. Typically, EVs implement battery packs capable of producing between 400V and 800V. As a result, most EVs include a DC-DC voltage converter, such as a stacked half bridge converter, which steps down the voltage of the battery pack to deliver the appropriate amount of voltage to the various low-voltage components of the EV.

A stacked half bridge converter is a type of DC-DC voltage converter that includes a first half bridge coupled in series with a second half bridge. The first half bridge includes a first transistor coupled in series with a second transistor, while the second half bridge includes a third transistor coupled in series with a fourth transistor. The type of transistors implemented by the stacked half bridge converter is application dependent. For example, if the application requires transistors with fast switching speeds and high operating temperatures (such as EVs), then the stacked half bridge converter may implement gallium nitride (GaN) transistors. A GaN transistor is a type of semiconducting device which is made from gallium nitride (rather than silicon), to allow for high electron mobility, and in turn, fast switching speeds and high operating temperatures.

Within the context of EVs, the stacked half bridge converter is used to charge an associated DC blocking capacitor to a voltage that is equal to half the input voltage. For example, if the EV battery pack is capable of producing 400V, then to soft start the voltage converter, the GaN transistors of the stacked half bridge converter are used to charge the DC blocking capacitor from a voltage of 0V to a voltage of 200V. Once charged, the GaN transistors of the stacked half bridge converter are then used to maintain the voltage of the DC blocking capacitor at the desired voltage level (e.g., 200V).

Some example GaN transistors are currently rated to handle a maximum of 650V, making them well-suited for applications that use a 400V voltage source. However, some EVs implement 800V battery packs, which exceed the voltage tolerance of GaN transistors, necessitating additional protection measures to ensure reliable operation. This is problematic because existing methods for soft starting a stacked half bridge converter that implements GaN transistors fail to protect the components of the EV system. For example, existing techniques are prone to errors, such as current spikes, which can damage the GaN transistors of the stacked half bridge converter. Consequently, these damages reduce the reliability of the EV, potentially leading to vehicular failure during operation.

Other solutions for soft starting a stacked half bridge converter use other types of transistors that are rated for an 800V voltage source. However, such solutions lack the advantages discussed above with respect to GaN transistors.

### SUMMARY

Disclosed herein is technology for enhanced soft starts for voltage converters that allows for the use of transistors in a system with a lower voltage rating than the voltage source of the system. In various implementations, a system comprising processing circuitry and a voltage converter including a first transistor, a second transistor, a third transistor, and a fourth transistor coupled in series between a voltage input and a ground is provided.

In one example embodiment, the processing circuitry is configured to, prior to a ramp-up period, operate the second transistor and the third transistor at a first duty cycle, and operate the first transistor and the fourth transistor at a second duty cycle. Next, during the ramp-up period, the processing circuitry is configured to continue to operate the second transistor and the third transistor at the first duty cycle, and cause an increase of the second duty cycle until the second duty cycle matches the first duty cycle, while maintaining the second duty cycle in-phase with respect to the first duty cycle. Finally, after the ramp-up period, the processing circuitry is configured to operate the first, second, third, and fourth transistors to transition the system from the first energy transfer state to a second energy transfer state.

This Summary is provided to introduce a selection of concepts in a simplified form that are further described below in the Detailed Description. It may be understood that this Summary is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates a system in an implementation.

FIG. 2 illustrates a control method in an implementation.

FIG. 3 illustrates another control method in an implementation.

FIG. 4 illustrates a steady-state sequence in an implementation

FIGS. 5A-5C illustrate operational graphs in various implementations.

FIG. 6 illustrates another operational graph in an implementation.

### DETAILED DESCRIPTION

Technology is disclosed herein that provides an improved process for soft starting a voltage converter that uses transistors with a lower voltage rating than the voltage source of the system. For example, the proposed technology may provide a soft starting technique that allows for the use of GaN transistors within a system that implements an 800V voltage source. A soft start in the context of this disclosure is a technique for gradually charging a capacitor to a voltage that is equal to half an input voltage via a voltage converter. The disclosed technique(s) may be implemented in the context of hardware, software, firmware, or a combination thereof to provide a method for soft starting a voltage converter which mitigates errors and protects the components of the associated system.

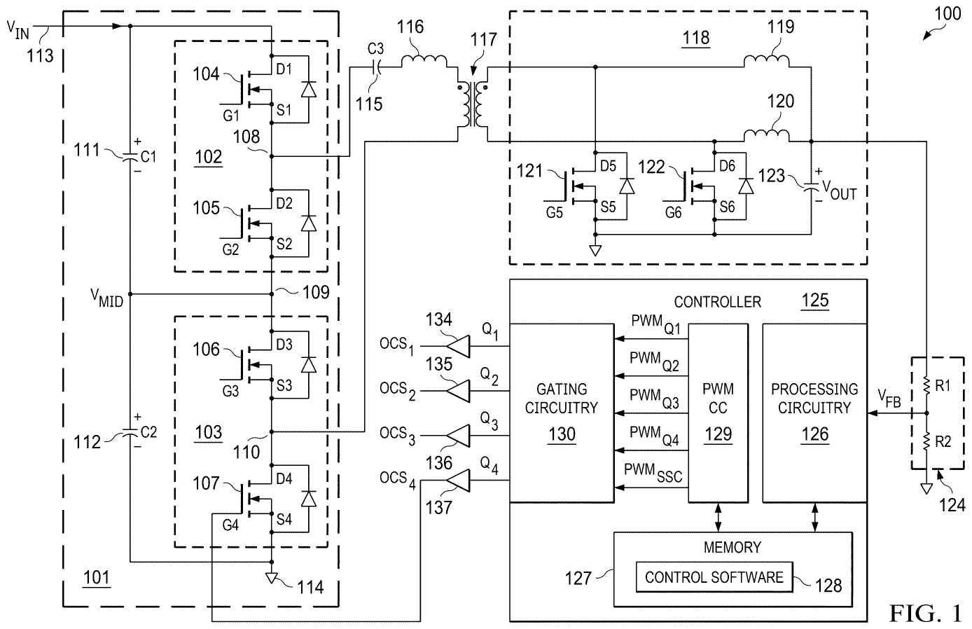

FIG. 1 illustrates system 100 in an implementation. System 100 is representative of an exemplary system that includes a voltage converter which converts high-voltage signals into low-voltage signals. For example, system 100 may be employed in an electric vehicle (EV) or other such environments that include a stacked half bridge converter. System 100 includes, but is not limited to, voltage converter 101, capacitor 115, inductor 116, transformer 117, current-doubler circuit 118, and controller 125. System 100 operates under two operative modes: a first energy transfer state or a second energy transfer state. The first energy transfer state refers to an operative mode where a negligible amount of energy is being transferred from capacitor 115 to a load of system 100 via one or more energy storage devices. The second energy transfer state refers to an operative mode where a non-zero amount of energy is being transferred from capacitor 115 to the other energy storage device(s) of system 100.

Voltage converter 101 is representative of circuitry that converts high-voltage signals into low-voltage signals. For example, voltage converter 101 may depict a stacked half bridge converter designed to charge and maintain capacitor 115 to a voltage that equals half the input voltage. In an implementation, when system 100 is operating under the first energy transfer state, voltage converter 101 charges capacitor 115 to a voltage that equals half the input voltage. For example, if voltage input 113 is supplying 800V to voltage converter 101, then during the first energy transfer state, voltage converter 101 may charge capacitor 115 to the 400V level. Alternatively, when system 100 is operating under the second energy transfer state, voltage converter 101 maintains the voltage of capacitor 115 at the desired voltage level. For example, if voltage input 113 is supplying 800V to voltage converter 101, then during the second energy transfer state, voltage converter 101 may maintain capacitor 115 at the 400V level. Voltage converter 101 includes half bridge 102, half bridge 103, capacitor 111, and capacitor 112.

Half bridge 102 and half bridge 103 are representative of switching circuits that provide a controlled amount of voltage to capacitor 115. For example, half bridges 102 and 103 may charge and maintain capacitor 115 at a voltage that is equal to half the input voltage. Half bridges 102 and 103 each comprise inner and outer transistors, such that half bridge 102 includes outer transistor 104 and inner transistor 105, and half bridge 103 includes inner transistor 106 and outer transistor 107, herein referred to as transistor 104, transistor 105, transistor 106, and transistor 107.

Transistors 104, 105, 106, and 107 are representative of circuit elements which control the current flow to capacitor 115, and in turn, the charge of capacitor 115. Transistors 104-107 may depict various types of transistors including bipolar junction transistors (BJTs), field effect transistors (FETs), metal-oxide-semiconductor field effect transistors (MOSFETs), or another transistor of the like, and for the purposes of explanation, transistors 104-107 represent gallium nitride (GaN) transistors with a voltage rating of 650V. This specification is not meant to limit the applications of transistors 104-107, but rather to provide an example.

A GaN transistor is a type of FET which is made from gallium nitride rather than the traditional silicon. GaN transistors provide various technical advantages over traditional FETs, including higher power density, faster switching speeds, improved thermal performance, and reduced size and weight. The use of GaN transistors within voltage converter 101 improves the efficiency and performance of system 100, while reducing the circuit cost.

In an implementation, the drain of transistor 104 (i.e., D1) is coupled to voltage input 113 that may be coupled to a voltage supply. For example, the drain of transistor 104 may be coupled to an EV battery pack that provides 800V to voltage converter 101 and serves as voltage input 113. Alternatively, the source of transistor 104 (i.e., S1) is coupled to node 108, and in turn, the drain of transistor 105 (i.e., D2).

Node 108 is representative of a midpoint node which connects transistor 104 to transistor 105 and further connects transistors 104 and 105 to capacitor 115. For example, node 108 may connect the source of transistor 104 and the drain of transistor 105 to an anode of capacitor 115. During operation, transistors 104 and 105 receive control signals which cause transistors 104 and 105 to apply a voltage at node 108, and in turn, the anode of capacitor 115. In an implementation, the voltage that is applied to the anode of capacitor 115 is equal to the voltage across capacitor 111.

Capacitor 111 is representative of a circuit element that stores energy for half bridge 102. In an implementation, the energy stored by capacitor 111 is proportional to half the input voltage. For example, if voltage input 113 is supplying 800V to voltage converter 101, then the voltage across capacitor 111 will be equal to 400V. During operation, controller 125 provides control signals to the gates of transistor 104 (i.e., G1) and transistor 105 (i.e., G2), to cause transistors 104 and 105 to transfer energy from capacitor 111 to capacitor 115

In an implementation, the drain of transistor 106 (i.e., D3) is coupled to the source of transistor 105 (i.e., S2) via node 109, the source of transistor 106 (i.e., S3) is coupled to the drain of transistor 107 (i.e., D4) via node 110, and the source of transistor 107 (i.e., S4) is coupled to ground 114. Node 109 is representative of a midpoint node which connects half bridge 102 to half bridge 103, such that the voltage at node 109 is equal to half the input voltage (i.e., V_{MID}). Alternatively, node 110 is representative of a midpoint node which connects transistor 106 to transistor 107. Additionally, node 110 connects transistors 106 and 107 to the primary winding of transformer 117, and in turn, capacitor 115. For example, the primary winding of transformer 117 may include a first terminal that is coupled to a cathode of capacitor 115, and a second terminal that is coupled to node 110. As a result, node 110 connects the source of transistor 106 and the drain of transistor 107 to the cathode of capacitor 115 via the second terminal of transformer 117. In some examples, an inductor, such as inductor 116 is coupled between the cathode capacitor 115 and the first terminal of transformer 117.

Capacitor 112 is representative of a circuit element that stores energy for half bridge 103. In an implementation, the energy stored by capacitor 112, as well as capacitor 111, is proportional to half the input voltage. For example, if voltage input 113 is supplying 800V to voltage converter 101, then the voltage across capacitors 111 and 112 will be equal to 400V. During operation, controller 125 provides control signals to the gates of transistor 106 (i.e., G3) and transistor 107 (i.e., G4), to cause transistors 106 and 107 to transfer energy from capacitor 112 to capacitor 115.

Capacitor 115 is representative of a circuit element (e.g., DC blocking capacitor) that transfers energy to the components of current-doubler circuit 118. For example, when system 100 is operating under the first energy transfer state, capacitor 115 transfers a negligible amount of energy to the components of current-doubler circuit 118. Alternatively, when system 100 is operating under the second energy transfer state, capacitor 115 transfers an appropriate amount of energy to the components of current-doubler circuit 118 via inductor 116 and transformer 117.

Inductor 116 is representative of a circuit element that may either provide a positive current to the primary winding of transformer 117 or receive a negative current from the primary winding of transformer 117. For example, during the first energy transfer state, inductor 116 may receive a negative current from the primary winding of transformer 117 and provide the negative current to capacitor 115. Alternatively, during the second energy transfer state, inductor 116 may provide a positive current to the primary winding of transformer 117 to cause transformer 117 to charge capacitor 123 to a desired low-voltage level.

Transformer 117 is representative of a circuit element that steps down the voltage output by capacitor 115. For example, during the second energy transfer state, capacitor 115 may provide a voltage which equals half the input voltage (e.g., 400V) to the primary winding of transformer 117, and in response, transformer 117 steps down the voltage to a desired low-voltage level (e.g., 12V). The secondary winding of transformer 117 may then provide the stepped down voltage to current-doubler circuit 118 to cause current-doubler circuit 118 to charge capacitor 123.

Current-doubler circuit 118 is representative of circuitry that generates a steady DC output based on the provided DC input, while doubling the available output current. For example, the secondary winding of transformer 117 may provide a DC input to current-doubler circuit 118, and in response, current-doubler circuit 118 may generate a steady DC output while doubling the available output current. Current-doubler circuit 118 includes inductors 119 and 120, transistors 121 and 122, and capacitor 123.

Inductors 119 and 120 are representative of circuit elements that generate the steady DC output while doubling the available output current. For example, inductors 119 and 120 may smooth the provided DC input to ensure that a consistent amount of current is flowing to the anode of capacitor 123. Additionally, the smoothed current generated by inductors 119 and 120 may be combined to double the available output current. In an implementation, inductor 119 is coupled to the drain of transistors 121 (i.e., D5), while inductor 120 is coupled to the drain of transistor 122 (i.e., D6).

Transistors 121 and 122 are representative of circuit elements which serve as synchronous rectifiers. For example, transistors 121 and 122 may include MOSFETS that switch on and off to control the direction of current flow. In an implementation, the source of transistor 121 (i.e., S5) and the source of transistor 122 (i.e., S6) are coupled to the cathode of capacitor 123.

Capacitor 123 may be part of a load and, in some examples, is representative of a circuit element that stores energy for the low-voltage components of system 100. For example, in the context of an EV, the low-voltage components may include systems (e.g., infotainment systems, safety systems, networking systems, auxiliary systems, etc.) which operate at a voltage of 12V, 24V, or 48V. In an implementation, when system 100 is operating under the first energy transfer state, capacitor 115 transfers a negligible amount of energy to capacitor 123. For example, during the first energy transfer state, the voltage across capacitor 123 (i.e., V_{OUT}) may be less than or equal to 2V. Alternatively, when operating under the second energy transfer state, capacitor 115 transfers an appropriate amount of energy to capacitor 123. For example, during the second energy transfer state, the voltage across capacitor 123 (i.e., V_{OUT}) may be less than or equal to 12V. In an implementation, the voltage across capacitor 123 is provided as feedback to controller 125. For example, capacitor 123 may be coupled to a voltage divider, such as voltage divider 124, that provides a feedback voltage (i.e., V_{FB}) which is proportional to the voltage across capacitor 123 (i.e., V_{OUT}) to controller 125.

Controller 125 represents circuitry that is responsible for controlling transistors 104, 105, 106, and 107. For example, controller 125 may depict a digital signal processor (DSP), central processing unit (CPU), microcontroller unit (MCU), application-specific integrated circuit (ASIC), or another general purpose processor (GPP) of the like configured to generate control signals for causing transistors 104, 105, 106, and 107 to soft start voltage converter 101. It should be noted that, the control signals may be amplified, buffered, and/or otherwise conditioned by gate drivers 134, 135, 136, and 137 and then provided to gates of transistors 104, 105, 106, and 107.

In an implementation, to soft start voltage converter 101, controller 125 generates control signals for transitioning system 100 from the first energy transfer state to the second energy transfer state. The first energy transfer state refers to the operative mode for when capacitor 115 is charged to a voltage that equals half the input voltage and a negligible amount of energy is being transferred from capacitor 115 to capacitor 123. Alternatively, the second energy transfer state refers to the operative mode for when capacitor 115 is maintained at the voltage that equals half the input voltage and a controlled amount of energy is being transferred from capacitor 115 to capacitor 123. Controller 125 includes processing circuitry 126, memory 127, PWM control circuitry 129, and gating circuitry 130.

Processing circuitry 126 is representative of circuitry that executes program code for soft starting voltage converter 101. For example, processing circuitry 126 may depict a CPU, MCU, microprocessor, ASIC, or another GPP of the like that is configured to execute program code for charging and maintaining capacitor 115 at a voltage that is equal to half the input voltage. In an implementation, processing circuitry 126 executes the program code stored by memory 127.

Memory 127 is representative of one or more volatile or non-volatile computer-readable storage media capable of storing program instructions and data. For example, memory 127 may be static random-access memory (SRAM), dynamic random-access memory (DRAM), non-volatile memory (e.g., flash memory), or another memory capable of storing control software 128. In no case is the computer readable storage media a propagated signal. Additionally, although illustrated as an on-chip memory, memory 127 may be representative of an off-chip memory that is accessible to controller 125.

Control software 128 is representative of program code that, when executed, causes the executing device to operate the system, which may include a soft start of the associated voltage converter. For example, when executed by processing circuitry 126, control software 128 causes voltage converter 101 to charge and maintain capacitor 115 at a voltage that equals half the input voltage. In an implementation, to charge capacitor 115, control software 128 causes processing circuitry 126 to generate control parameters that designate the desired duty cycle for operating transistors 104, 105, 106, and 107. For example, processing circuitry 126 may generate a first control parameter corresponding to transistor 104, a second control parameter corresponding to transistor 105, a third control parameter corresponding to transistor 106, a fourth control parameter corresponding to transistor 107, and a fifth control parameter associated with the first and fourth control parameters. Once generated, processing circuitry 126 provides the first, second, third, fourth, and fifth control parameters to PWM control circuitry 129. In an implementation, to provide the control parameters to PWM control circuitry 129, processing circuitry 126 stores the first, second, third, fourth, and fifth control parameters in the registers which are accessible to PWM control circuitry 129. For example, processing circuitry 126 may store the first, second, third, fourth, and fifth control parameters in registers of memory 127.

PWM control circuitry 129 is representative of circuitry that generates PWM control signals for operating transistors 104, 105, 106, and 107 based on the provided control parameters. For example, PWM control circuitry 129 may depict an MCU, microprocessor, ASIC, or another GPP of the like configured to serve as a PWM controller. In an implementation, PWM control circuitry 129 accesses the first, second, third, fourth, and fifth control parameters from the registers of memory 127, and in response, generates a first PWM control signal (i.e., PWM_{Q1}) corresponding to transistor 104, a second PWM control signal (i.e., PWM_{Q2}) corresponding to transistor 105, a third PWM control signal (i.e., PWM_{Q3}) corresponding to transistor 106, a fourth PWM control signal (i.e., PWM_{Q4}) corresponding to transistor 107, and a fifth PWM control signal (i.e., PWM_{SSC}) associated with the first and fourth control signals. Once generated, PWM control circuitry 129 provides the first, second, third, fourth, and fifth PWM control signals to gating circuitry 130.

Gating circuitry 130 is representative of circuitry configured to generate control signals for operating transistors 104, 105, 106, and 107 based on the provided PWM control signals. For example, gating circuitry 130 may depict an MCU, microprocessor, ASIC, or another GPP of the like configured to generate control signals for operating transistors 104, 105, 106, and 107. In an implementation, gating circuitry 130 receives the first, second, third, fourth, and fifth PWM control signals from PWM control circuitry 129, and in response, generates a first control signal (i.e., Q₁) corresponding to transistor 104, a second control signal (i.e., Q₂) corresponding to transistor 105, a third control signal (i.e., Q₃) corresponding to transistor 106, and a fourth control signal (i.e., Q₄) corresponding to transistor 107. Once generated, gating circuitry 130 respectively provides the first, second, third, and fourth, control signals to gate drivers 134, 135, 136, and 137.

Gate drivers 134, 135, 136, and 137 represent circuit elements that generate output control signals for operating transistors 104, 105, 106, and 107. For example, after receiving the first, second, and fourth control signals from gating circuitry 130, gate driver 134 may generate a first output control signal (i.e., OCS₁) for operating transistor 104, gate driver 135 may generate a second output control signal (i.e., OCS₂) for operating transistor 105, gate driver 136 may generate a third output control signal (i.e., OCS₃) for operating transistor 106, and gate driver 137 may generate a fourth output control signal (i.e., OCS₄) for operating transistor 107. Once generated, gate driver 134 may provide the first output control signal to the gate of transistor 104, gate driver 135 may provide the second output control signal to the gate of transistor 105, gate driver 136 may provide the third output control signal to the gate of transistor 106, and gate driver 137 may provide the fourth output control signal to the gate of transistor 107. In response, transistors 104, 105, 106, and 107 may operate in accordance with the provided output control signals.

Additional example details for system 100 can be found in commonly assigned U.S. patent application Ser. No. 17/957,897, entitled “Pulse Width Modulator for a Stacked Half Bridge”, filed Sep. 9, 2022, which is incorporated by reference in its entirety.

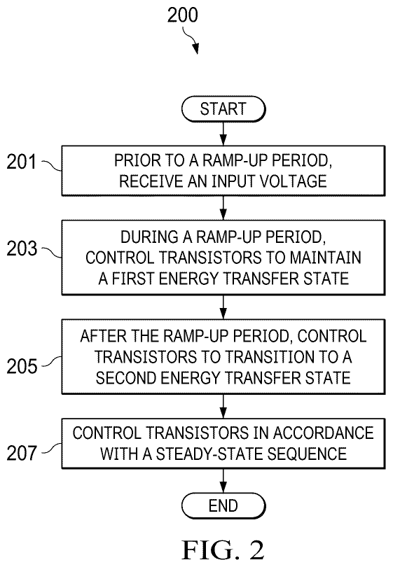

FIG. 2 illustrates control method 200 implemented by control software 128 in the context of system 100. Control method 200 is representative of a technique for soft starting a voltage converter that implements transistors with a lower voltage rating than the voltage source of the system. For example, control method 200 may depict a technique for safely transitioning a system from a first energy transfer state to a second energy transfer state. Control method 200, when executed by processing circuitry 126, causes controller 125 to operate as follows, referring parenthetically to the steps in FIG. 2 and to the elements of FIG. 1 for the sake of clarity.

At the beginning of control method 200 (prior to a ramp-up period), voltage input 113 supplies an input voltage to voltage converter 101 (step 201). For example, voltage input 113 may begin supplying 800V to voltage converter 101, and in response, processing circuitry 126 executes control software 128. In an implementation, prior to the ramp-up period, control software 128 causes processing circuitry 126 to operate transistors 105 and 106 at a first duty cycle and transistors 104 and 107 at a second duty cycle in-phase with respect to the first duty cycle. For example, while maintaining the first energy transfer state of system 100, processing circuitry 126 may operate transistors 105 and 106 at a 50% duty cycle and transistors 104 and 107 at a 0% duty cycle, and processing circuitry 126 may maintain a zero-degree phase difference between transistors 104 and 106, as well as between transistors 105 and 107 as the duty cycle of transistors 104 and 107 increases from 0%.

To operate transistors 104, 105, 106, and 107 in-phase with each other at the respective duty cycles, PWM control circuitry 129 and gating circuitry 130 of controller 125 cause gate drivers 134, 135, 136, and 137 to generate a set of output control signals that operate transistors 104, 105, 106, and 107 accordingly. For example, PWM control circuitry 129 and gating circuitry 130 may cause gate driver 134 to generate a first output control signal OCS₁ for operating transistor 104 at the 0% duty cycle. PWM control circuitry 129 and gating circuitry 130 may also cause gate drivers 135 and 136 to respectively generate a second output control signal OCS₂ and a third output control signal OCS₃ for operating transistors 105 and 106 at the 50% duty cycle. Additionally, PWM control circuitry 129 and gating circuitry 130 may cause gate driver 137 to generate a fourth output control signal OCS₄ for operating transistor 107 at the 0% duty cycle.

In an implementation, to generate the output control signals OCS₁, OCS₂, OCS₃, and OCS₄ processing circuitry 126 generates a first control parameter corresponding to transistor 104, a second control parameter corresponding to transistor 105, a third control parameter corresponding to transistor 106, a fourth control parameter corresponding to transistor 107, and a fifth control parameter associated with the first and fourth control parameters. The control parameters designate the desired duty cycle for generating the output control signals. For example, prior to the ramp-up period, the first, second, third, and fourth control parameters may designate a 50% duty cycle, while the fifth control parameter designates a 0% duty cycle.

Next, processing circuitry 126 provides the first, second, third, fourth, and fifth control parameters to PWM control circuitry 129 to cause PWM control circuitry 129 to generate a first PWM control signal PWM_{Q1} reflecting a 50% duty cycle, a second PWM control signal PWM_{Q2} reflecting a 50% duty cycle, a third PWM control signal PWM_{Q3} reflecting a 50% duty cycle, a fourth PWM control signal PWM_{Q4} reflecting a 50% duty cycle, and a fifth PWM control signal PWM_{SSC} reflecting a 0% duty cycle. For example, processing circuitry 126 may store the first, second, third, fourth, and fifth control parameters in registers of memory 127. In response, PWM control circuitry 129 may access the first, second, third, fourth, and fifth control parameters and generate the first PWM control signal PWM_{Q1} reflecting the 50% duty cycle, the second PWM control signal PWM_{Q2} reflecting the 50% duty cycle, the third PWM control signal PWM_{Q3} reflecting the 50% duty cycle, the fourth PWM control signal PWM_{Q4} reflecting the 50% duty cycle, and the fifth PWM control signal PWM_{SSC} reflecting the 0% duty cycle. Once generated, the PWM control signals PWM_{Q1}, PWM_{Q2}, PWM_{Q3}, PWM_{Q4}, and PWM_{SSC} may be provided to gating circuitry 130 to cause gating circuitry 130 to produce a first control signal Q₁ reflecting a 0% duty cycle, a second control signal Q₂ reflecting a 50% duty cycle, a third control signal Q₃ reflecting a 50% duty cycle, and a fourth control signal Q₄ reflecting a 0% duty cycle.

In an implementation, to generate the first control signal Q₁, gating circuitry 130 performs an AND operation between the first PWM control signal PWM_{Q1} and the fifth PWM control signal PWM_{SSC}. For example, gating circuitry 130 may perform an AND operation between the first PWM control signal PWM_{Q1} designating the 50% duty cycle and the fifth PWM control signal PWM_{SSC} designating the 0% duty cycle. As a result, gating circuitry 130 generates the first control signal Q₁ designating a duty cycle of 0%. Similarly, to generate the fourth control signal Q₄, gating circuitry 130 performs an AND operation between the fourth PWM control signal PWM_{Q4} and the fifth PWM control signal PWM_{SSC}. For example, gating circuitry 130 may perform an AND operation between the fourth PWM control signal PWM_{Q4} designating the 50% duty cycle and the fifth PWM control signal PWM_{SSC} designating the 0% duty cycle. As a result, gating circuitry 130 generates the fourth control signal Q₄ designating a duty cycle of 0%.

In an implementation, to generate the second and third control signals Q₂ and Q₃, gating circuitry 130 respectively converts the second PWM control signal PWM_{Q2} and the third PWM control signal PWM_{Q3} into the second control signal Q₂ and the third control signal Q₃. For example, if the second and third PWM control signals PWM_{Q2} and PWM_{Q3} designate the 50% duty cycle, then gating circuitry 130 may generate a second control signal Q₂ and a third control signal Q₃, that also designate the 50% duty cycle. Once generated, gating circuitry 130 may respectively provide the first control signal Q₁, the second control signal Q₂, the third control signal Q₃, and fourth control signal Q₄ to gate drivers 134, 135, 136, and 137.

In response, gate drivers 134, 135, 136, and 137 generate the output control signals OCS₁, OCS₂, OCS₃, and OCS₄for operating transistors 104, 105, 106, and 107 in-phase with each other at the respective duty cycle. For example, gate driver 134 generates a first output control signal OCS₁, having a duty cycle of 0%, and transmits the first output control signal OCS₁to the gate of transistor 104. Gate driver 135 generates a second output control signal OCS₂, having a duty cycle of 50%, and transmits the second output control signal OCS₂to the gate of transistor 105. Gate driver 136 generates a third output control signal OCS₃, having a duty cycle of 50%, and transmits the third output control signal OCS₃to the gate of transistor 106. Meanwhile, gate driver 137 generates a fourth output control signal OCS₄, having a duty cycle of 0%, and transmits the fourth output control signal OCS₄to the gate of transistor 107. As a result, controller 125 causes transistors 105 and 106 to operate at the 50% duty cycle, and transistors 104 and 107 to operate at the 0% duty cycle, with a zero-degree phase difference between transistors 104 and 106, and transistors 105 and 107, and with an 180-degree phase difference between transistors 104 and 105, transistors 105 and 106, transistors 106 and 107, and transistors 107 and 104. Additionally, controller 125 maintains system 100 within the first energy transfer state, such that prior to the ramp-up period, the voltage across capacitor 115 is equal to (or nearly equal to) 0V.

Next, during the ramp-up period, processing circuitry 126 causes voltage converter to maintain system 100 within the first energy transfer state while increasing the voltage across capacitor 115 (step 203). For example, during the ramp-up period, processing circuitry 126 may charge capacitor 115 to the voltage that equals half the input voltage, while ensuring a negligible amount of energy is being transferred from capacitor 115 to capacitor 123. In an implementation, during the ramp-up period, control software 128 causes processing circuitry 126 to continue to operate transistors 105 and 106 at the first duty cycle, while causing an increase of the second duty cycle of transistors 104 and 107 until the second duty cycle matches the first duty cycle. For example, while maintaining the first energy transfer state of system 100, processing circuitry 126 may continue to operate transistors 105 and 106 at the 50% duty cycle, while increasing the duty cycle of transistors 104 and 107 from 0% to 50%. In an implementation, to increase the duty cycle of transistors 104 and 107, processing circuitry 126 adjusts the fifth control parameter over a series of processing cycles.

For example, during each processing cycle, processing circuitry 126 increases the fifth control parameter by a percentage amount and stores the increased parameter within the corresponding register. Once stored, PWM control circuitry 129 accesses the first, second, third, fourth, and fifth control parameters, and generates the first PWM control signal PWM_{Q1}, the second PWM control signal PWM_{Q2}, the third PWM control signal PWM_{Q3}, the fourth PWM control signal PWM_{Q4}, and the fifth PWM control signal PWM_{SSC}. Once generated, PWM control circuitry 129 provides the PWM control signals PWM_{Q1}, PWM_{Q2}, PWM_{Q3}, PWM_{Q4}, and PWM_{SSC} to gating circuitry 130, and in response, gating circuitry 130 generates the first control signal Q₁, the second control signal Q₂, the third control signal Q₂, and fourth control signal Q₄. Gating circuitry 130 may then respectively provide the first, second, third, and fourth control signals Q₁-Q₄ to gate drivers 134, 135, 136, and 137. In response, gate drivers 134, 135, 136, and 137 generate the first, second, third, and fourth output control signals OCS₁-OCS₄, and respectively transmit the first, second, third, and fourth output control signals OCS₁-OCS₄ to the gates of transistor 104, 105, 106, and 107.

In an implementation, during the ramp-up period, processing circuitry 126 increases the fifth control parameter from designating a duty cycle of 0% to designating a duty cycle of 100%. As a result, processing circuitry 126 causes PWM control circuitry 129 and gating circuitry 130 to increase the first and fourth control signals Q₁ and Q₄ from designating a duty cycle of 0% to designating a duty cycle of 50%. In other words, during the ramp-up period, control software 128 causes processing circuitry 126 to increase the duty cycle for operating transistors 104 and 107 from 0% to 50%, while operating transistors 105 and 106 at the 50% duty cycle.

It should be noted that, while increasing the second duty cycle to match the first duty cycle, control software 128 causes processing circuitry 126 to maintain the desired phase differences between transistors 104, 105, 106, and 107. For example, processing circuitry 126 may maintain a zero-degree phase difference between transistors 104 and 106, and transistors 105 and 107, and further maintain an 180-degree phase difference between transistors 104 and 105, transistors 105 and 106, transistors 106 and 107, and transistors 107 and 104.

Next, processing circuitry 126 determines whether to transition system 100 from operating under the first energy transfer state to operating under the second energy transfer state. For example, processing circuitry 126 may determine if capacitor 115 has been charged to a voltage that equals half the input voltage. In an implementation, to determine if capacitor 115 has been charged to the desired voltage level, processing circuitry 126 measures the elapsed time. For example, processing circuitry 126 may count the number of executed processing cycles to determine if enough time has elapsed to charge capacitor 115 to a voltage that equals half the input voltage. In another implementation, to determine if capacitor 115 has been charged to the desired voltage level, processing circuitry 126 may read the voltage across capacitor 115. For example, processing circuitry 126 may be coupled to a voltage sensor that measures the voltage across capacitor 115 and provides the readings to processing circuitry 126, allowing processing circuitry 126 to determine if the voltage across capacitor 115 equals half the input voltage. Similarly, in another implementation, processing circuitry 126 may determine if capacitor 115 has been charged to the desired voltage level by analyzing the feedback voltage (i.e., V_{FB}) provided by voltage divider 124.

After the completion of the ramp-up period, control software 128 causes processing circuitry 126 to operate transistors 104, 105, 106, and 107 in a manner which transitions system 100 from the first energy transfer state to the second energy transfer state (step 205). For example, once the voltage across capacitor 115 is equal to half the input voltage, control software 128 may cause processing circuitry 126 to begin iteratively modifying the first, second, third, and fourth control parameters based on a steady-state sequence that defines the desired transistor states (i.e., on-state or off-state) for operating transistors 104-107 under the second energy transfer state. The steady-state sequence refers to a sequence that gradually causes capacitor 115 to transfer its energy to current-doubler circuit 118, and in turn, capacitor 123. For example, the steady-state sequence may cause the voltage across capacitor 123 to increase from a negligible voltage level to a desired low-voltage level (e.g., 12V, 24V, or 48V). Additionally, the steady-state sequence refers to a sequence that maintains capacitor 115 at the desired voltage level. For example, if voltage input 113 is providing 800V to voltage converter 101, then the steady-state sequence causes transistors 104, 105, 106, and 107 to maintain capacitor 115 at the 400V voltage level.

In an implementation, the steady-state sequence includes four states that repeat in the following order: (1) first state, (2) second state, (3) fourth state, (4) second state, (5) first state, (6) third state, (7) fourth state, and (8) third state. The first state indicates that the desired transistor state for operating transistors 104 and 107 is the on-state, while the desired transistor state for operating transistors 105 and 106 is the off-state. The second state indicates that the desired transistor state for operating transistors 104 and 106 is the on-state, while the desired transistor state for operating transistors 105 and 107 is the off-state. The third state indicates that the desired transistor state for operating transistors 104 and 106 is the off-state, while the desired transistor state for operating transistors 105 and 107 is the on-state. The fourth state indicates that the desired transistor state for operating transistors 104 and 107 is the off-state, while the desired transistor state for operating transistors 105 and 106 is the on-state.

Processing circuitry 126 iteratively modifies the first, second, third, and fourth control parameters until the first, second, third, and fourth control parameters follow the steady-state sequence as defined for the transistors. For example, over a series of processing cycles, processing circuitry 126 may introduce various time delays to the first, second, third, and fourth control parameters. Processing circuitry 126 then provides the updated control parameters to PWM control circuitry 129, and in response, the PWM control circuitry generates a corresponding set of updated PWM control signals. PWM control circuitry 129 then provides the updated PWM control signals to gating circuitry 130, and in response, gating circuitry 130 generates a corresponding set of updated control signals. Gating circuitry 130 then provides the updated control signals to gate drivers 134, 135, 136, and 137 to cause gate drivers 134, 135, 136, and 137 to generate updated output control signals for transistors 104, 105, 106, and 107. As a result, processing circuitry 126 causes capacitor 115 to transfer an appropriate amount of energy to capacitor 123. For example, if the low-voltage components of system 100 require 24V to operate, then processing circuitry 126 causes capacitor 115 to charge capacitor 123 to the 24V level.

After capacitor 123 has been charged to the target voltage level, control software 128 causes processing circuitry 126 to continue operating transistors 104, 105, 106, and 107 in accordance with the steady-state sequence (step 207). For example, after the voltage across capacitor 123 has been increased to 24V, controller 125 may continue to generate output control signals which follow the steady-state sequence. As a result, processing circuitry 126 causes voltage converter 101 to maintain the voltages across capacitors 115 and 123 at the desired voltage levels.

It may be appreciated that, in alternative implementations, control software 128 causes processing circuitry 126 to instead operate transistors 104 and 107 at the first duty cycle and operate transistors 105 and 106 at the second duty cycle in-phase with respect to the first duty cycle. For example, processing circuitry 126 may operate the inner transistors (i.e., transistors 105 and 106) at the second duty cycle in-phase with respect to the first duty cycle, or alternatively, operate the outer transistors (i.e., transistors 104 and 107) at the second duty cycle in-phase with respect to the first duty cycle. It should be noted that in either implementation, the phase differences between transistors 104, 105, 106, and 107 remain the same.

Advantageously, control method 200 provides a technique for soft starting a voltage converter in a system, which mitigates the chances of damaging components within the system. As such, control method 200 provides a technique for transitioning a system from a first energy transfer state to a second energy transfer state, thereby allowing the voltage converter of the system to safely charge the associated capacitors. Additionally, control method 200 provides a technique which allows for the use of GaN transistors within an environment that includes an 800V voltage source. As a result, control method 200 provides a technique which improves the switching speed and operating temperatures of the associated system, while reducing the system cost.

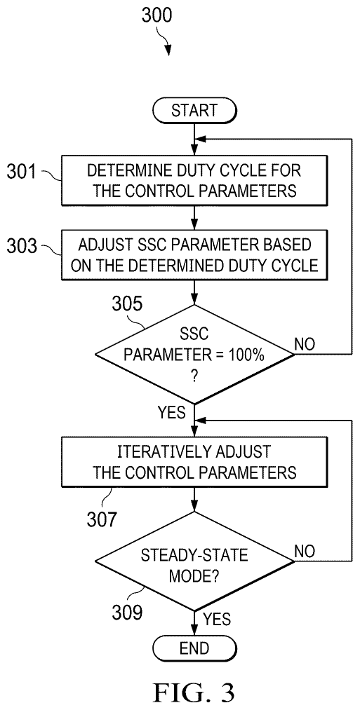

FIG. 3 illustrates control method 300 in an implementation. Control method 300 is representative of a software or firmware algorithm for operating a voltage converter which implements transistors with a lower voltage rating than the voltage source of the associated system. For example, control method 300 may represent the software that safely transitions a system from a first energy transfer state to a second energy transfer state. In an implementation, control method 300 is implemented within the context of control software 128, such that during operation, when executed by processing circuitry 126, control software 128 causes controller 125 to generate control signals for operating transistors 104, 105, 106, and 107 under the first energy transfer state and the second energy transfer state. For the purposes of explanation, control method 300 will be explained with respect to transistor 104 of FIG. 1, referring parenthetically to the steps in FIG. 3. This specification is not meant to limit the applications of control method 300, but rather to provide an example.

To begin, voltage input 113 supplies an input voltage to voltage converter 101 to initiate the soft start of voltage converter 101. For example, voltage input 113 may begin supplying 800V to voltage converter 101. In response, processing circuitry 126 may determine the desired duty cycles for the first control parameter and the fifth control parameter when operating under the first energy transfer state (step 301).

For example, when operating under the first energy transfer state, processing circuitry 126 may determine that the first control parameter should be set to a 50% duty cycle, while the fifth control parameter, herein referred to as the soft-start control (SSC) parameter, should be set to a 0% duty cycle. Processing circuitry 126 may then generate the first control parameter, and the SSC parameter, based on the determined duty cycles (step 303). Once generated, processing circuitry 126 may provide the first control parameter and the SSC parameter to PWM control circuitry 129. For example, processing circuitry 126 may store the first control parameter and the SSC parameter in registers of memory 127. Once stored, PWM control circuitry 129 may access the parameters to generate a first PWM control signal PWM_{Q1} reflecting the duty cycle of the first control parameter and a fifth PWM control signal PWM_{SSC} reflecting the duty cycle of the SSC parameter. For example, if the first control parameter designates a 50% duty cycle and the SSC parameter designates a 0% duty cycle, then PWM control circuitry 129 generates the first PWM control signal PWM_{Q1} reflecting the 50% duty cycle and the fifth PWM control signal PWM_{SSC} reflecting the 0% duty cycle. Once generated, PWM control circuitry 129 may provide the first PWM control signal PWM_{Q1} and the fifth PWM control signal PWM_{SSC} to gating circuitry 130. In response, gating circuitry 130 may generate a first control signal Q₁ by performing an AND operation between the first PWM control signal PWM_{Q1} reflecting the 50% duty cycle and the fifth PWM control signal PWM_{SSC} reflecting the 0% duty cycle. As a result, gating circuitry 130 generates the first control signal Q₁ having a duty cycle of 0%. Gating circuitry 130 may then provide the first control signal Q₁ to gate driver 134 to cause gate driver 134 to generate a first output control signal OCS₁ that causes transistor 104 to operate at the 0% duty cycle.

Then, prior to the next processing cycle, processing circuitry 126 determines if the duty cycle of the SSC parameter has reached 100% (step 305). If the duty cycle of the SSC parameter has not yet reached 100%, then, processing circuitry 126 continues to generate control parameters for operating transistor 104 under the first energy transfer state. For example, processing circuitry 126 may determine to increase the duty cycle for the SSC parameter by a percentage amount over a series of processing cycles (step 301). Processing circuitry 126 may then adjust the duty cycle of the SSC parameter (step 303) and provide the first control parameter (still designating a duty cycle of 50%) and the adjusted SSC parameter to PWM control circuitry 129. In response, PWM control circuitry 129 generates the first PWM control signal PWM_{Q1} and an updated version of the fifth PWM control signal PWM_{SSC}. Once generated, PWM control circuitry 129 provides the first PWM control signal PWM_{Q1} and the updated version of the fifth PWM control signal PWM_{SSC} to gating circuitry 130 to cause gating circuitry 130 to perform an AND operation between PWM_{Q1} and PWM_{SSC}. As a result, gating circuitry 130 generates an updated version of the first control signal Q₁, and provides the updated version of the first control signal Q₁ to gate driver 134. In response, gate driver 134 generates an updated version of the first output control signal OCS₁ and provides the updated version of the first output control signal OCS₁ to the gate of transistor 104.

Once the duty cycle of the SSC parameter has reached 100%, processing circuitry 126 transitions system 100 to operating under the second energy transfer state by iteratively adjusting the first control parameter based on the steady-state sequence defined for voltage converter 101 (step 307). For example, the steady-state sequence may include four states that repeat in the following order: (1) first state, (2) second state, (3) fourth state, (4) second state, (5) first state, (6) third state, (7) fourth state, and (8) third state, such that the first and second states indicate that the desired transistor state for operating transistor 104 is the on-state, and the third and fourth states indicate that the desired transistor state for operating transistor 104 is the off-state.

In an implementation, to iteratively adjust the first control parameter, processing circuitry 126 introduces various time delays to the first control parameter. For example, processing circuitry 126 may phase shift the first control parameter by a percentage amount over a series of processing cycles. Then, after each processing cycle, processing circuitry 126 may determine if the first control parameter matches the steady-state sequence as defined for transistor 104 (step 309). If the first control parameter does not match the steady-state sequence, then processing circuitry 126 continues to iteratively adjust the parameter (step 309). Alternatively, if the first control parameter matches the steady-state sequence, then processing circuity 126 continues to maintain system 100 within the second energy transfer state.

Advantageously, control method 300 provides a soft starting technique for safely charging and maintaining capacitor 115 to a voltage that is equal to half the input voltage, as well as safely charging and maintaining capacitor 123 to a desired low-voltage level. As a result, control method 300 provides software which mitigates the chances of damaging components within a system while transitioning the system from the first energy transfer state to the second energy transfer state. Additionally, control method 300 provides a soft starting technique which allows for the use of GaN transistors within an environment that includes an 800V voltage source, thereby improving the switching speed and operating temperatures of the associated system, while reducing the system cost.

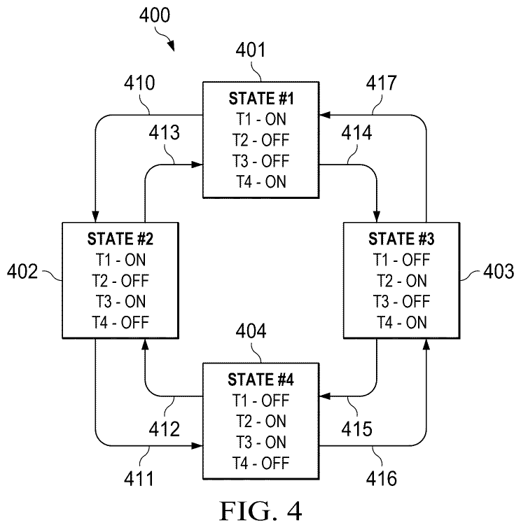

FIG. 4 illustrates steady-state state machine diagram 400 in an implementation, herein referred to as diagram 400. Diagram 400 provides a visualization for the state machine logic that is used to operate the transistors of a stacked half bridge converter during the second energy transfer state. For example, diagram 400 may provide a visualization for the state machine logic that is used after voltage converter 101 has charged capacitor 115 to the target-voltage level (e.g., 400V). In an implementation, the state machine logic of diagram 400 is implemented in the context of program code. For example, the state machine logic of diagram 400 may be implemented within the context of control software 128. For the purposes of explanation, diagram 400 will be explained with the elements of FIG. 1. This specification is not meant to limit the applications of diagram 400, but rather to provide an example. Diagram 400 includes state 401, state 402, state 403, and state 404.

State 401 is representative of a first operative mode which defines the desired transistor states for operating transistor 104-107. In an implementation, state 401 defines that the desired transistor state for operating transistor 104 (i.e., T1) is the on-state, the desired transistor state for operating transistor 105 (i.e., T2) is the off-state, the desired transistor state for operating transistor 106 (i.e., T3) is the off-state, and the desired transistor state for operating transistor 107 (i.e., T4) is the on-state.

State 402 is representative of a second operative mode which also defines the desired transistor states for operating transistor 104-107. In an implementation, state 402 defines that the desired transistor state for operating transistor 104 is the on-state, the desired transistor state for operating transistor 105 is the off-state, the desired transistor state for operating transistor 106 is the on-state, and the desired transistor state for operating transistor 107 is the off-state.

State 403 is representative of a third operative mode which defines the desired transistor states for operating transistor 104-107. In an implementation, state 403 defines that the desired transistor state for operating transistor 104 is the off-state, the desired transistor state for operating transistor 105 is the on-state, the desired transistor state for operating transistor 106 is the off-state, and the desired transistor state for operating transistor 107 is the on-state.

State 404 is representative of a fourth operative mode which also defines the desired transistor states for operating transistor 104-107. In an implementation, state 404 defines that the desired transistor state for operating transistor 104 is the off-state, the desired transistor state for operating transistor 105 is the on-state, the desired transistor state for operating transistor 106 is the on-state, and the desired transistor state for operating transistor 107 is the off-state.

In a brief operational example, after charging capacitor 115 to the target-voltage level, processing circuitry 126 transitions between the states depicted by diagram 400 with each processing cycle. For example, during a first processing cycle, processing circuitry 126 executes state 401 and operates transistor 104 in the on-state, transistor 105 in the off-state, transistor 106 in the off-state, and transistor 107 in the on-state. Then, during a second processing cycle, processing circuitry 126 transitions from executing state 401 to executing state 402, as indicated by arrow 410. As a result, processing circuitry 126 operates transistor 104 in the on-state, transistor 105 in the off-state, transistor 106 in the on-state, and transistor 107 in the off-state.

Next, during a third processing cycle, processing circuitry 126 transitions from executing state 402 to executing state 404, as indicated by arrow 411. As a result, processing circuitry 126 operates transistor 104 in the off-state, transistor 105 in the on-state, transistor 106 in the on-state, and transistor 107 in the off-state. Then, during a fourth processing cycle, processing circuitry 126 transitions from executing state 404 back to executing state 402, as indicated by arrow 412. As a result, processing circuitry 126 operates transistor 104 in the on-state, transistor 105 in the off-state, transistor 106 in the on-state, and transistor 107 in the off-state.

Subsequently, during a fifth processing cycle, processing circuitry 126 transitions from executing state 402 to executing state 401, as indicated by arrow 413. As a result, processing circuitry 126 operates transistor 104 in the on-state, transistor 105 in the off-state, transistor 106 in the off-state, and transistor 107 in the on-state. Then, during a sixth processing cycle, processing circuitry 126 transitions from executing state 401 to executing state 403, as indicated by arrow 414. As a result, processing circuitry 126 operates transistor 104 in the off-state, transistor 105 in the on-state, transistor 106 in the off-state, and transistor 107 in the on-state.

Next, during a seventh processing cycle, processing circuitry 126 transitions from executing state 403 to executing state 404, as indicated by arrow 415. As a result, processing circuitry 126 operates transistor 104 in the off-state, transistor 105 in the on-state, transistor 106 in the on-state, and transistor 107 in the off-state. Then, during an eighth processing cycle, processing circuitry 126 transitions from executing state 404 back to executing state 403, as indicated by arrow 416. As a result, processing circuitry 126 operates transistor 104 in the off-state, transistor 105 in the on-state, transistor 106 in the off-state, and transistor 107 in the on-state.

Subsequently, during a ninth processing cycle, processing circuitry 126 transitions from executing state 403 back to executing state 401, as indicated by arrow 417. As a result, processing circuitry 126 operates transistor 104 in the on-state, transistor 105 in the off-state, transistor 106 in the off-state, and transistor 107 in the on-state. In an implementation, processing circuitry 126 repeats the above process for the remaining processing cycles. For example, processing circuitry 126 may repeat the following sequence of states: (1) state 401, (2) state 402, (3) state 404, (4) state 402, (5) state 401, (6) state 403, (7) state 404, and (8) state 403 for the remaining processing cycles.

Additional example details for diagram 400 can be found in commonly assigned U.S. patent application Ser. No. 17/957,897, entitled “Pulse Width Modulator for a Stacked Half Bridge”, filed Sep. 9, 2022, which is incorporated by reference in its entirety.

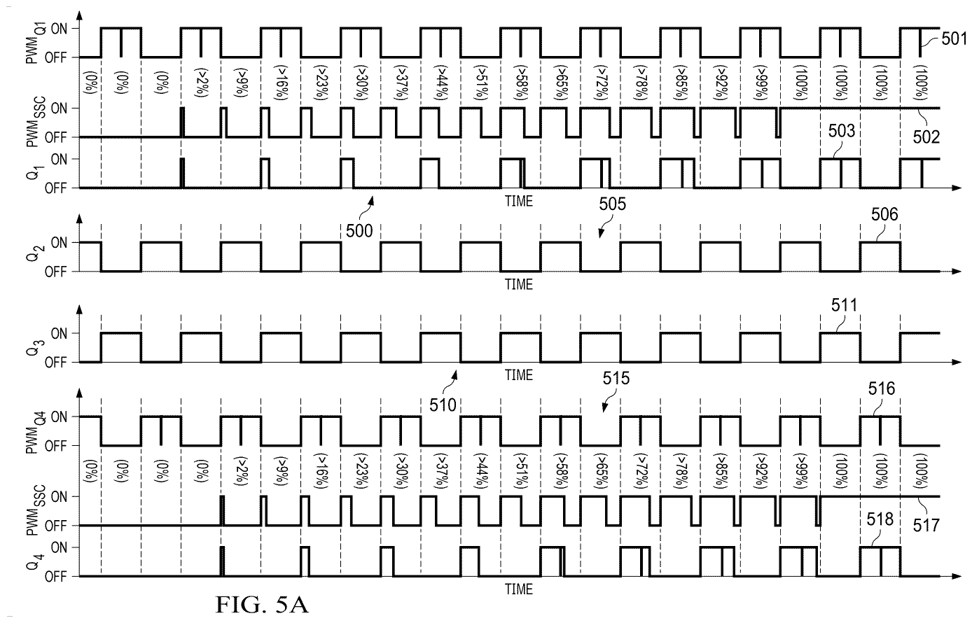

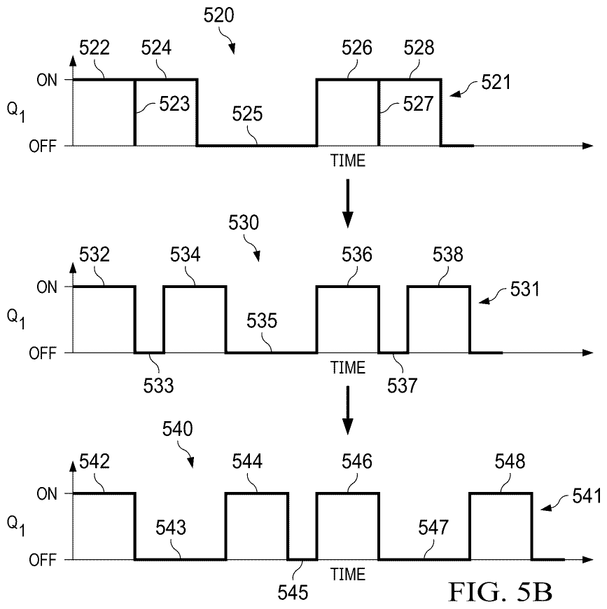

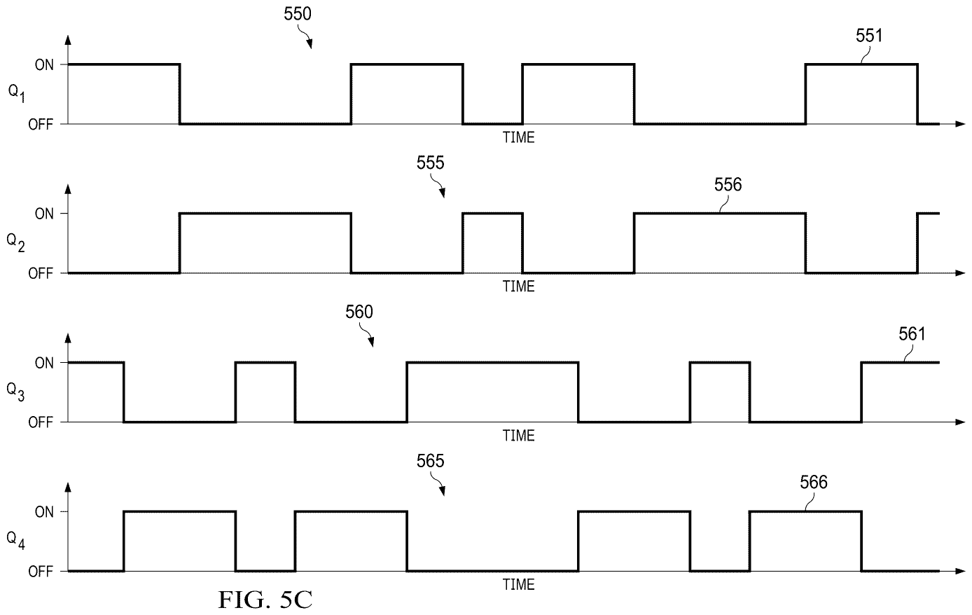

FIG. 5A illustrates graphs 500, 505, 510, and 515 in an implementation. Graphs 500, 505, 510, and 515 are representative of operational graphs which depict the control signals for operating the transistors of a voltage converter during the first energy transfer state (i.e., prior to, and during the ramp-up period). For example, graphs 500, 505, 510, and 515 may depict the control signals for causing the voltage across an associated capacitor to increase to a voltage that equals half the input voltage. For the purposes of explanation, graphs 500, 505, 510, and 515 will be explained with the elements of FIG. 1. This specification is not meant to limit the applications of graphs 500, 505, 510, and 515, but rather to provide an example.

Graph 500 is representative of an operational graph which depicts the control signals for operating transistor 104 during the first energy transfer state. Graph 500 includes PWM control signal 501 (i.e., PWM_{Q1}), PWM control signal 502 (i.e., PWM_{SSC}), and control signal 503 (i.e., Q₁). PWM control signals 501 and 502 are representative of input control signals. For example, PWM control signals 501 and 502 may represent the inputs for generating control signal 503. In an implementation, PWM control signal 501 depicts a nearly symmetrical waveform including a 50% (or nearly 50%) duty cycle, while PWM control signal 502 depicts an asymmetrical waveform including a duty cycle increase from 0% to 100%. For example, PWM control signal 501 may represent the waveform that is associated with the first control parameter. Meanwhile, PWM control signal 502 may represent the waveform that is associated with the SSC parameter. In an implementation, processing circuitry 126 executes control method 300 to cause PWM control circuitry 129 to generate PWM control signals 501 and 502.

For example, during the first set of processing cycles of the first energy transfer state, processing circuitry 126 may determine that the duty cycle for the first control parameter includes a 50% duty cycle, while the duty cycle for the SSC parameter includes a 0% duty cycle, as represented by PWM control signals 501 and 502. Once determined, processing circuitry 126 may provide the first control parameter designating a 50% duty cycle and the SSC parameter designating a 0% duty cycle to PWM control circuitry 129. For example, processing circuitry 126 may store the first control parameter and the SSC parameter in registers of memory 127, and in response, PWM control circuitry 129 may access the parameters and generate PWM control signal 501 reflecting the 50% duty cycle and PWM control signal 502 reflecting the 0% duty cycle. PWM control circuitry 129 may then provide PWM control signals 501 and 502 to gating circuitry 130 to cause gating circuitry 130 to perform an AND operation between PWM control signal 501 and PWM control signal 502. As a result, gating circuitry generates control signal 503 reflecting a duty cycle of 0% and provides control signal 503 to gate driver 134 to cause gate driver 134 to generate a first output control signal OCS₁ for operating transistor 104 at the 0% duty cycle.

Then, during the remaining processing cycles of the first energy transfer state, processing circuitry 126 may gradually adjust the SSC parameter from designating a duty cycle of 0% to designating a duty cycle of 100%. For example, during each processing cycle, processing circuitry 126 may increase the duty cycle of the SSC parameter by a percentage amount. Once increased, processing circuitry 126 may provide the first control parameter (still designating a duty cycle of 50%) and the updated SSC parameter to PWM control circuitry 129. In response, PWM control circuitry 129 generates PWM control signal 501 and an updated version of PWM control signal 502 and provides the signals to gating circuitry 130. Gating circuitry 130 may then perform an AND operation between PWM control signal 501 and the updated version of PWM control signal 502 to generate an updated version of control signal 503. Gating circuitry 130 may then provide the updated version of control signal 503 to gate driver 134 to cause gate driver 134 to generate an updated version of the first output control signal OCS₁. It should be noted that processing circuitry 126 may update the SSC parameter after a number of processing cycles rather than every processing cycle. For example, processing circuitry 126 may update the SSC parameter every n-processing cycles.

Control signal 503 is representative of the signal for operating transistor 104 during the first energy transfer state. For example, control signal 503 may depict a signal with a duty cycle that increases from 0% to 50%. In an implementation, control signal 503 is provided as input to gate driver 134. For example, gating circuitry 130 may provide control signal 503 to gate driver 134, and in response, gate driver 134 may generate the first output control signal OCS₁. Once generated, gate driver 134 may provide the first output control signal OCS₁ to the gate of transistor 104 to cause transistor 104 to transition from operating at the 0% duty cycle to operating at the 50% (or nearly 50%) duty cycle.

Graph 505 is representative of an operational graph which depicts the control signal for operating transistor 105 during the first energy transfer state. Graph 505 includes control signal 506 (i.e., Q₂). Control signal 506 is representative of the signal for operating transistor 105 during the first energy transfer state. For example, during the first energy transfer state, processing circuitry 126 may provide a second control parameter designating a 50% duty cycle to PWM control circuitry 129. In response, PWM control circuitry 129 generates a second PWM control signal PWM_{Q2}, also designating the 50% duty cycle. PWM control circuitry 129 may then provide the second PWM control signal PWM_{Q2} to gating circuitry 130 to cause gating circuitry 130 to generate control signal 506. Once generated, gating circuitry 130 may provide control signal 506 to gate driver 135, and in response, gate driver 135 may generate the second output control signal OCS₂ and provide the second output control signal OCS₂ to the gate of transistor 105. As a result, gate driver 135 causes transistor 105 to operate at the 50% (or nearly 50%) duty cycle, while maintaining an 180-degree phase difference between transistors 104 and 105, as well as between transistors 105 and 106.

Graph 510 is representative of an operational graph which depicts the control signal for operating transistor 106 during the first energy transfer state. Graph 510 includes control signal 511 (i.e., Q₃). Control signal 511 represents the signal for operating transistor 106 during the first energy transfer state. For example, during the first energy transfer state, processing circuitry 126 may provide a third control parameter designating a 50% duty cycle to PWM control circuitry 129. In response, PWM control circuitry 129 may generate a third PWM control signal PWM_{Q3}, also designating the 50% duty cycle, and provide the third PWM control signal PWM_{Q3} to gating circuitry 130. Gating circuitry 130 may then generate control signal 511 and provide control signal 511 to gate driver 136. In response, gate driver 136 may generate the third output control signal OCS₃ and provide the third output control signal OCS₃ to the gate of transistor 106. As a result, gate driver 136 causes transistor 106 to operate at the 50% (or nearly 50%) duty cycle.

Graph 515 is representative of an operational graph which depicts the control signals for operating transistor 107 during the first energy transfer state. Graph 500 includes PWM control signal 516 (i.e., PWM_{Q4}), PWM control signal 517 (i.e., PWM_{SSC}), and control signal 518 (i.e., Q₄). PWM control signals 516 and 517 are representative of input control signals. For example, PWM control signals 516 and 517 may represent the inputs for generating control signal 518. In an implementation, PWM control signal 516 depicts a nearly symmetrical waveform including a 50% (or nearly 50%) duty cycle, while PWM control signal 517 depicts an asymmetrical waveform including a duty cycle increase from 0% to 100%. For example, PWM control signal 516 may represent the waveform that is associated with the fourth control parameter. Meanwhile, PWM control signal 517 may represent the waveform (i.e., PWM control signal 502) that is associated with the SSC parameter. In an implementation, processing circuitry 126 executes control method 300 to cause PWM control circuitry 129 to generate PWM control signals 516 and 517.

For example, during the first set of processing cycles of the first energy transfer state, processing circuitry 126 may determine that the duty cycle for the fourth control parameter includes a 50% duty cycle, while the duty cycle for the SSC parameter includes a 0% duty cycle, as represented by PWM control signals 516 and 517. Once determined, processing circuitry 126 may provide the fourth control parameter designating a 50% duty cycle and the SSC parameter designating a 0% duty cycle to PWM control circuitry 129. For example, processing circuitry 126 may store the fourth control parameter and the SSC parameter in registers of memory 127, and in response, PWM control circuitry 129 may access the parameters and generate PWM control signal 516 reflecting the 50% duty cycle and PWM control signal 517 reflecting the 0% duty cycle. PWM control circuitry 129 may then provide PWM control signals 516 and 517 to gating circuitry 130 to cause gating circuitry 130 to perform an AND operation between PWM control signal 516 and PWM control signal 517. As a result, gating circuitry generates control signal 518 reflecting a duty cycle of 0% and provides control signal 518 to gate driver 137 to cause gate driver 137 to generate a fourth output control signal OCS₄ for operating transistor 107 at the 0% duty cycle.

Then, during the remaining processing cycles of the first energy transfer state, processing circuitry 126 may gradually adjust the SSC parameter from designating a duty cycle of 0% to designating a duty cycle of 100%. For example, after n-processing cycles, processing circuitry 126 may increase the duty cycle of the SSC parameter by a percentage amount. Once increased, processing circuitry 126 may provide the fourth control parameter (still designating a duty cycle of 50%) and the updated SSC parameter to PWM control circuitry 129. In response, PWM control circuitry 129 generates PWM control signal 516 and an updated version of PWM control signal 517 and provides the signals to gating circuitry 130. Gating circuitry 130 may then perform an AND operation between PWM control signal 516 and the updated version of PWM control signal 517 to generate an updated version of control signal 518. Gating circuitry 130 may then provide the updated version of control signal 518 to gate driver 137 to cause gate driver 137 to generate an updated version of the fourth output control signal OCS₄.

Control signal 518 is representative of the signal for operating transistor 107 during the first energy transfer state. For example, control signal 518 may depict a signal with a duty cycle that increases from 0% to 50%. In an implementation, control signal 518 is provided as input to gate driver 137. For example, gating circuitry 130 may provide control signal 518 to gate driver 137, and in response, gate driver 137 may generate the fourth output control signal OCS₄. Once generated, gate driver 137 may provide the fourth output control signal OCS₄ to the gate of transistor 107. As a result, gate driver 137 causes transistor 107 to transition from operating at the 0% duty cycle to operating at the 50% (or nearly 50%) duty cycle, while maintaining an 180-degree phase difference between transistors 106 and 107, as well as between transistors 104 and 107.

FIG. 5B illustrates graphs 520, 530, and 540 in an implementation. Graphs 520, 530, and 540 are representative of operational graphs which depict the control signals for operating the transistors of a voltage converter when transitioning the system from the first energy transfer state to the second energy transfer state. For example, graphs 520, 530, and 540 may depict the control signals for operating the transistors of a voltage converter after the associated capacitor has been charged to a voltage that equals half the input voltage. For the purposes of explanation, graphs 520, 530, and 540 will be explained with the elements of FIG. 1. This specification is not meant to limit the applications of graphs 520, 530, and 540, but rather to provide an example. Graph 520 includes control signal 521 (i.e., Q₁), graph 530 includes control signal 531 (i.e., Q₁), and graph 540 includes control signal 541 (i.e., Q₁).

Control signal 521 is representative of a signal for turning an associated transistor on an off at a desired rate. For example, control signal 521 may depict the signal that is generated by gating circuitry 130 and supplied to gate driver 134 for operating transistor 104 at a nearly 50% duty cycle. In an implementation, after the duty cycle of the SSC parameter equals 100%, processing circuitry 126 transitions system 100 from the first energy transfer state to the second energy transfer state. For example, processing circuitry 126 may cause PWM control circuitry 129 and gating circuitry 130 to modify control signal 521 to follow the steady-state sequence as defined by diagram 400. In an implementation, to modify control signal 521, processing circuitry 126 phase shifts the first control parameter. For example, processing circuitry 126 may introduce various time delays to the first control parameter, and in turn, cause gating circuitry 130 to introduce various time delays to control signal 521. As a result, processing circuitry 126 causes gating circuitry 130 to transition segments 522, 523, 524, 525, 526, 527, and 528 into segments 532, 533, 534, 535, 536, 537, and 538, as depicted by control signal 531.

Control signal 531 is representative of a modified version of control signal 521. For example, when modifying control signal 521 to follow the steady-state sequence as defined for transistor 104, processing circuitry 126 may introduce time delays that increase the width of segments 523 and 527, but decrease the width of segment 525. As a result, processing circuitry 126 causes gating circuitry 130 to generate control signal 531, including segments, 532, 533, 534, 535, 536, 537, and 538. In an implementation, processing circuitry 126 continues to cause PWM control circuitry 129 and gating circuitry 130 to modify control signal 521 until control signal 521 follows the steady-state sequence as defined for transistor 104, as depicted by control signal 541.

Control signal 541 is representative of a modified version of control signal 531. For example, when modifying control signal 531, processing circuitry 126 may introduce time delays that continue to increase the width of segments 533 and 537, while continuing to decrease the width of segment 535. As a result, processing circuitry causes gating circuitry 130 to generate control signal 541, including segments, 542, 543, 544, 545, 546, 547, and 548. In an implementation, control signal 541 depicts the waveform which follows the steady-state sequence as defined for transistor 104.

FIG. 5C illustrates graphs 550, 555, 560, and 565 in an implementation. Graphs 550, 555, 560, and 565 are representative of operational graphs which depict the control signals for operating the transistors of a voltage converter during the second energy transfer state. For example, graph 550, 555, 560, and 565 may respectively depict the control signals generated by gating circuitry 130 for operating transistors 104, 105, 106, and 107 during the second energy transfer state. For the purposes of explanation, graphs 550, 555, 560, and 565 will be explained with the elements of FIG. 1. This specification is not meant to limit the applications of graphs 550, 555, 560, and 565, but rather to provide an example. Graph 550 includes control signal 551, graph 555 includes control signal 556, graph 560 includes control signal 561, and graph 565 includes control signal 566.

Control signals 551, 556, 561, and 566 depict the waveforms that follow the steady-state sequence as defined by diagram 400. For example, control signal 551 may depict the steady-state sequence defined for transistor 104, control signal 556 may depict the steady-state sequence defined for transistor 105, control signal 561 may depict the steady-state sequence defined for transistor 106, and control signal 566 may depict the steady-state sequence defined for transistor 107. Additionally, it should be noted that, control signal 556 depicts the complement of control signal 551, while control signal 561 depicts the complement of control signal 566.

In an implementation, if transistors 104, 105, 106, and 107 are operating in accordance with diagram 400, then system 100 is within a steady-state mode, and the voltages across capacitors 115 and 123 are equal to the target voltages. For example, if voltage input 113 is supplying 800V to system 100, and gating circuitry 130 is respectively generating control signals 551, 556, 561, and 566, then, the voltage across capacitor 115 may be equal to 400V, while the voltage across capacitor 123 may be equal to 12V.

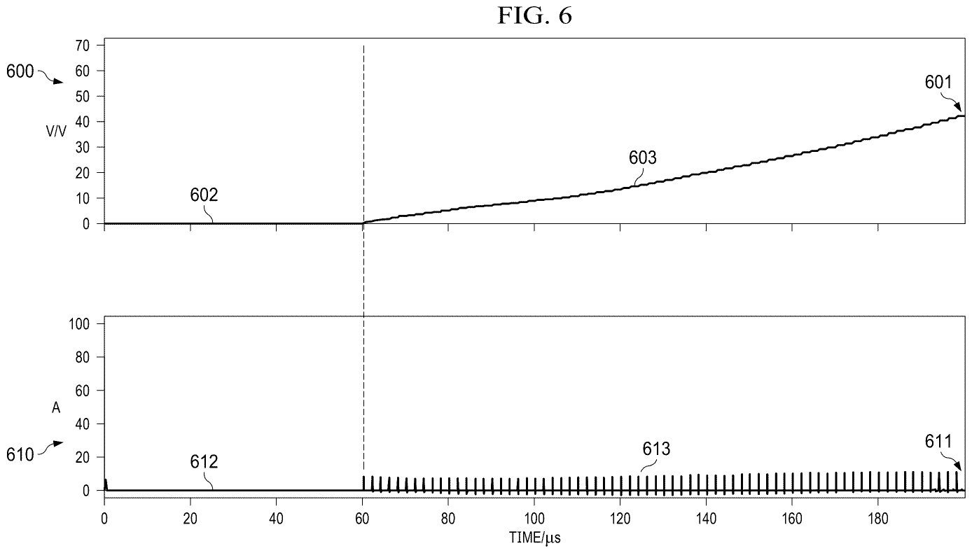

FIG. 6 illustrates graph 600 and graph 610 in an implementation. Graph 600 is representative of an operational graph which depicts the voltage across a capacitor during the soft start of a voltage converter. Alternatively, graph 610 is representative of an operational graph which depicts the current flow across said capacitor during the soft start of the voltage converter. For example, graph 600 may depict the voltage across capacitor 115 for when system 100 is operating under the first energy transfer state. Meanwhile, graph 610 may depict the current across capacitor 115 for when system 100 is operating under the first energy transfer state. For the purposes of explanation, graphs 600 and 610 will be explained with the elements of FIG. 1. This specification is not meant to limit the applications of graphs 600 and 610, but rather to provide an example. Graph 600 includes signal 601 while graph 610 includes signal 611.

Signal 601 represents the signal that depicts the voltage across capacitor 115 during the first energy transfer state. In an implementation, during a first section of the first energy transfer state, the voltage across capacitor 115 is equal to 0V, as depicted by segment 602. For example, if transistors 104 and 107 are operating at the 0% duty cycle, then voltage across capacitor 115 may be equal to 0V. Subsequently, during a next section of the first energy transfer state, the voltage across capacitor 115 begins to increase to the target voltage level, as depicted by segment 603. For example, when the duty cycle of transistors 104 and 107 are increased from 0% to 50%, the voltage across capacitor 115 may begin to increase to the 400V level.

Signal 611 represents the signal that depicts the current across capacitor 115 during the first energy transfer state. In an implementation, when the voltage across capacitor 115 is equal to 0V, then no current is allowed to flow across capacitor 115, as depicted by segment 602. Alternatively, when the voltage across capacitor 115 begins increasing to the target voltage level, then current is allowed to flow across capacitor 115, as depicted by segment 613.

In an implementation, controller 125 charges capacitor 115 to a voltage that is equal to half the input voltage while protecting the components of system 100. For example, if voltage input 113 is an 800V voltage source, and transistors 104, 105, 106, and 107 are GaN transistors with a voltage rating of 650V, then processing circuitry 126 may execute control method 300 to safely charge capacitor 115 to a voltage of 400V, and in turn, safely charge capacitor 123 to the desired low-voltage level. In an implementation, controller 125 causes voltage converter 101 to charge capacitor 115 during the first energy transfer state. As a result, processing circuitry 126 causes system 100 to safely charge capacitor 115 without inducing current spikes which may damage the components of the system, as depicted by graph 610.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

As used herein, the terms “terminal”, “node”, “interconnection”, “pin” and “lead” are used interchangeably. Unless specifically stated to the contrary, these terms are generally used to mean an interconnection between or a terminus of a device element, a circuit element, an integrated circuit, a device or other electronics or semiconductor component.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

While the use of particular transistors is described herein, other transistors (or equivalent devices) may be used instead with little or no change to the remaining circuitry. For example, a bipolar junction transistor (BJT—e.g. NPN or PNP), an insulated gate bipolar transistor (IGBT), and/or a junction field effect transistor (JFET) may be used in place of or in conjunction with the transistors described herein. The transistors may be depletion mode devices, drain-extended devices, enhancement mode devices, natural transistors or other types of device structure transistors. Furthermore, the devices may be implemented in/over a silicon substrate (Si), a silicon carbide substrate (SiC), a gallium nitride substrate (GaN) or a gallium arsenide substrate (GaAs).

References herein to a transistor being in the “on-state” means that the conduction channel of the transistor is present and drain current may flow through the transistor. References herein to a transistor being in the “off-state” means that the conduction channel is not present, so drain current does not flow through the transistor. An “off-state” transistor, however, may have current flowing through the transistor's body-diode

Circuits described herein are reconfigurable to include additional or different components to provide functionality at least partially similar to functionality available prior to the component replacement. Components shown as resistors, unless otherwise stated, are generally representative of any one or more elements coupled in series and/or parallel to provide an amount of impedance represented by the resistor shown. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor.

While certain elements of the described examples are included in an integrated circuit and other elements are external to the integrated circuit, in other example embodiments, additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

Uses of the phrase “ground” in the foregoing description include a chassis ground, an Earth ground, a floating ground, a virtual ground, a digital ground, a common ground, and/or any other form of ground connection applicable to, or suitable for, the teachings of this description. In this description, unless otherwise stated, “about,” “approximately” or “substantially” preceding a parameter means being within +/−10 percent of that parameter.

Modifications are possible in the described embodiments, and other embodiments are possible, within the scope of the claims.

As will be appreciated by one skilled in the art, aspects of the present invention may be embodied as a system, method, or computer program product. Accordingly, aspects of the present invention may take the form of an entirely hardware implementation, an entirely software implementation (including firmware, resident software, micro-code, etc.) or an implementation combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Indeed, the included descriptions and figures depict specific implementations to teach those skilled in the art how to make and use the best mode. For the purpose of teaching inventive principles, some conventional aspects have been simplified or omitted. Those skilled in the art will appreciate variations from these implementations that fall within the scope of the disclosure. Those skilled in the art will also appreciate that the features described above may be combined in various ways to form multiple implementations. As a result, the invention is not limited to the specific implementations described above, but only by the claims and their equivalents.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. Thus, the invention is not limited to the specific embodiments described above, but only by the following claims and their equivalents.

What is claimed is:

1. A system comprising:
voltage converter circuitry that includes a first transistor, a second transistor, a third transistor, and a fourth transistor coupled in series between a voltage input and a ground; and
processing circuitry operatively coupled with the voltage converter circuitry and operable to:
prior to a ramp-up period, operate the second transistor and the third transistor at a first duty cycle, and operate the first transistor and the fourth transistor at a second duty cycle;
during the ramp-up period, continue to operate the second transistor and the third transistor at the first duty cycle, and cause an increase of the second duty cycle until the second duty cycle matches the first duty cycle, while maintaining the second duty cycle in-phase with respect to the first duty cycle; and
after the ramp-up period, operate the first transistor, the second transistor, the third transistor, and the fourth transistor to transition the system from a first energy transfer state to a second energy transfer state.

2. The system of claim 1, wherein the processing circuitry comprises pulse-width modulation (PWM) control circuitry, and wherein the processing circuitry is operable to provide, to the PWM control circuitry, a first control parameter corresponding to the first transistor, a second control parameter corresponding to the second transistor, a third control parameter corresponding to the third transistor, a fourth control parameter corresponding to the fourth transistor, and a fifth control parameter associated with the first control parameter and the fourth control parameter.

3. The system of claim 2, wherein:
the PWM control circuitry is operable to provide a first PWM control signal, a second PWM control signal, a third PWM control signal, a fourth PWM control signal, and a fifth PWM control signal based on the first control parameter, the second control parameter, the third control parameter, the fourth control parameter, and the fifth control parameter;
the processing circuitry comprises gating circuitry coupled to the PWM control circuitry; and
to operate the first transistor at the second duty cycle, the gating circuitry performs an AND operation of the first PWM control signal and the fifth PWM control signal, resulting in a first control signal, and operates the first transistor based on the first control signal.

4. The system of claim 3, wherein to operate the fourth transistor at the second duty cycle, the gating circuitry performs an AND operation of the fourth PWM control signal and the fifth PWM control signal, resulting in a fourth control signal, and operates the fourth transistor based on the fourth control signal.

5. The system of claim 4, wherein during the ramp-up period, to cause the increase of the second duty cycle until the second duty cycle matches the first duty cycle, the processing circuitry is operable to adjust the fifth control parameter to cause the second duty cycle to increase from zero percent to fifty percent.

6. The system of claim 5, wherein after the ramp-up period, to transition the system from the first energy transfer state to the second energy transfer state, the processing circuitry is operable to iteratively modify the first control parameter until the first control parameter comprises a first steady-state sequence defined for the first transistor.

7. The system of claim 6, wherein after the ramp-up period, to transition the system from the first energy transfer state to the second energy transfer state, the processing circuitry is further operable to iteratively modify the fourth control parameter until the fourth control parameter comprises a fourth steady-state sequence defined for the fourth transistor.

8. The system of claim 7, wherein during the ramp-up period, the first control signal associated with the first control parameter is symmetrical or nearly symmetrical, and wherein, after the ramp-up period, the first control signal associated with the first control parameter is asymmetrical.

9. The system of claim 8, wherein during the ramp-up period, the fourth control signal associated with the fourth control parameter is symmetrical or nearly symmetrical, and wherein, after the ramp-up period, the fourth control signal associated with the fourth control parameter is asymmetrical.

10. The system of claim 9, wherein:
during the ramp-up period, a second control signal associated with the second control parameter is symmetrical or nearly symmetrical;
after the ramp-up period, the second control signal comprises a complement of the first control signal;
during the ramp-up period, a third control signal associated with the third control parameter is symmetrical or nearly symmetrical; and
after the ramp-up period, the third control signal comprises a complement of the fourth control signal.

11. The system of claim 1, further comprising:
a transformer that includes a first terminal and a second terminal; and
a direct-current blocking capacitor that includes an anode coupled between the first transistor and the second transistor and a cathode coupled to the first terminal of the transformer; and
wherein the second terminal of the transformer is coupled between the third transistor and the fourth transistor.

12. A processing device comprising:
a memory having program instructions stored thereon for controlling voltage converter circuitry that includes a first transistor, a second transistor, a third transistor, and a fourth transistor coupled in series between a voltage input and a ground; and
processing circuitry operatively coupled to the memory and the voltage converter circuitry;
wherein the program instructions, when read and executed by the processing circuitry, direct the processing device to at least:
prior to a ramp-up period, operate the second transistor and the third transistor at a first duty cycle, and operate the first transistor and the fourth transistor at a second duty cycle;
during the ramp-up period, continue to operate the second transistor and the third transistor at the first duty cycle, and cause an increase of the second duty cycle until the second duty cycle matches the first duty cycle, while maintaining the second duty cycle in-phase with respect to the first duty cycle; and
after the ramp-up period, operate the first transistor, the second transistor, the third transistor, and the fourth transistor to transition the voltage converter circuitry from a first energy transfer state to a second energy transfer state.

13. The processing device of claim 12, wherein the processing circuitry comprises pulse-width modulation (PWM) control circuitry, and wherein the program instructions, when executed by the processing circuitry, direct the processing device to provide, to the PWM control circuitry, a first control parameter corresponding to the first transistor, a second control parameter corresponding to the second transistor, a third control parameter corresponding to the third transistor, a fourth control parameter corresponding to the fourth transistor, and a fifth control parameter associated with the first control parameter and the fourth control parameter.

14. The processing device of claim 13, wherein:
the PWM control circuitry is operable to provide a first PWM control signal, a second PWM control signal, a third PWM control signal, a fourth PWM control signal, and a fifth PWM control signal based on the first control parameter, the second control parameter, the third control parameter, the fourth control parameter, and the fifth control parameter;
the processing circuitry comprises gating circuitry coupled to the PWM control circuitry; and
to operate the first transistor at the second duty cycle, the gating circuitry performs an AND operation of the first PWM control signal and the fifth PWM control signal, resulting in a first control signal, and operates the first transistor based on the first control signal.

15. The processing device of claim 14, wherein to operate the fourth transistor at the second duty cycle, the gating circuitry performs an AND operation of the fourth PWM control signal and the fifth PWM control signal, resulting in a fourth control signal, and operates the fourth transistor based on the fourth control signal.

16. The processing device of claim 15, wherein during the ramp-up period, to cause the increase of the second duty cycle until the second duty cycle matches the first duty cycle, the program instructions direct the processing circuitry to adjust the fifth control parameter to cause the second duty cycle to increase from zero percent to fifty percent.

17. The processing device of claim 16, wherein after the ramp-up period, to transition the voltage converter circuitry from the first energy transfer state to the second energy transfer state, the program instructions direct the processing circuitry to iteratively modify the first control parameter until the first control parameter comprises a first steady-state sequence defined for the first transistor.

18. The processing device of claim 17, wherein after the ramp-up period, to transition the voltage converter circuitry from the first energy transfer state to the second energy transfer state, the program instructions direct the processing circuitry to iteratively modify the fourth control parameter until the fourth control parameter comprises a fourth steady-state sequence defined for the fourth transistor.

19. The processing device of claim 12, wherein:
the first transistor and the second transistor are coupled to an anode of a direct-current blocking capacitor;
the third transistor and the fourth transistor are coupled to a second terminal of a transformer; and
a cathode of the direct-current blocking capacitor is coupled to a first terminal of the transformer.

20. A method for controlling voltage converter circuitry that includes a first transistor, a second transistor, a third transistor, and a fourth transistor coupled in series between a voltage input and a ground, the method comprising:
by processing circuitry coupled to the voltage converter circuitry:
prior to a ramp-up period, operate the second transistor and the third transistor at a first duty cycle, and operate the first transistor and the fourth transistor at a second duty cycle;
during the ramp-up period, continue to operate the second transistor and the third transistor at the first duty cycle, and cause an increase of the second duty cycle until the second duty cycle matches the first duty cycle, while maintaining the second duty cycle in-phase with respect to the first duty cycle; and
after the ramp-up period, operate the first transistor, the second transistor, the third transistor, and the fourth transistor to transition the voltage converter circuitry from a first energy transfer state to a second energy transfer state.
